(19) United States
(12) Patent Application Publication
(10) Pub. No.: US 2024/0250393 A1
(43) Pub. Date: Jul. 25, 2024

(54) PCBA CONFIGURATION FOR VOLTAGE/TEMPERATURE SENSING

(71) Applicant: Enphase Energy, Inc., Pataluma, CA (US)

(72) Inventors: Christopher McNair LYKE, Austin, TX (US); Wei JIANG, Round Rock, TX (US); Vikram Nandakumar IYENGAR, Austin, TX (US)

(21) Appl. No.: 18/405,194

(22) Filed: Jan. 5, 2024

Related U.S. Application Data
(60) Provisional application No. 63/441,071, filed on Jan. 25, 2023.

(51) Int. Cl. H01M 50/569; H01M 10/42; H01M 50/519

(52) U.S. Cl. CPC H01M 50/569; H01M 10/425; H01M 50/519; H01M 2010/4271

(57) ABSTRACT

The present disclosure provides a battery pack configured for use with an energy storage system. For example, the battery pack can comprise a battery cell and a printed circuit board assembly comprising a metal strip configured to connect to the battery cell and provide at least one of temperature or voltage data of the battery cell to a battery management unit operably coupled to the printed circuit board assembly.

### CROSS-REFERENCE TO RELATED APPLICATIONS

The present application claims the benefit of and priority to U.S. Provisional Application Ser. No. 63/441,071, filed on Jan. 25, 2023, the entire contents of which is incorporated herein by reference.

### BACKGROUND

### Field of the Disclosure

Embodiments of the present disclosure relate generally to energy storage systems, and, for example, to energy storage systems comprising printed circuit board assembly configurations for voltage/temperature sensing.

### Description of the Related Art

Conventional energy storage systems (battery systems) use a battery management unit (BMU) protection board that monitors voltages and temperatures of cells of a battery pack to prevent overcharge, overdischarge, overcurrent, and/or short circuit. For example, when a battery pack comprises many cells, a wire harness and/or ring lug can often be used to connect the BMU to one or more thermistors and voltage connectors. The thermistors can sometimes be attached to the cells using epoxy or other suitable attachment devices. Most voltage and temperature sensing harnesses require some amount of manual assembly and require a significant amount of wire and connectors.

Accordingly, there is a need for improved energy storage systems comprising printed circuit board assembly configuration for voltage/temperature sensing.

### SUMMARY

Energy storage systems comprising printed circuit board assembly configurations for voltage/temperature sensing are provided herein. For example, in accordance with some aspects of the disclosure, a battery pack configured for use with an energy storage system comprises a battery cell and a printed circuit board assembly comprising a metal strip configured to connect to the battery cell and provide at least one of temperature or voltage data of the battery cell to a battery management unit operably coupled to the printed circuit board assembly.

In accordance with some aspects of the disclosure, an energy management system comprises a distributed energy resource comprising a renewable energy source, a load center connected to the renewable energy source, and an energy storage system comprising a battery pack comprising a battery cell and a printed circuit board assembly comprising a metal strip configured to connect to the battery cell and provide at least one of temperature or voltage data of the battery cell to a battery management unit operably coupled to the printed circuit board assembly.

These and other features and advantages of the present disclosure may be appreciated from a review of the following detailed description of the present disclosure, along with the accompanying figures in which like reference numerals refer to like parts throughout.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only typical embodiments of this disclosure and are therefore not to be considered limiting of its scope, for the disclosure may admit to other equally effective embodiments.

FIG. 1 is a block diagram of an energy management system, in accordance with one or more embodiments of the present disclosure;

FIGS. 2A-2B are diagrams of a prismatic cell electrical configuration, in accordance with one or more embodiments of the present disclosure; and

FIGS. 3A-3B are diagrams of a prismatic cell electrical configuration, in accordance with one or more embodiments of the present disclosure.

### DETAILED DESCRIPTION

Embodiments of the present disclosure relate to improved energy storage systems comprising printed circuit board assembly (PCBA) configuration for at least one of temperature or voltage sensing. For example, a battery pack configured for use with an energy storage system comprises a battery cell and a printed circuit board assembly comprising a metal strip configured to connect to the battery cell and provide at least one of temperature or voltage data of the battery cell to a battery management unit operably coupled to the printed circuit board assembly. The PCBA configurations described herein can be assembled in a relatively easy manner onto one of more cells of a battery pack and can directly measure temperature and voltage. Accordingly, the PCBA configurations described herein can reduce assembly time and design complexity. The PCBA configurations described herein provide can be connected/disconnected to/from battery cells to a PCBA in a relatively quick manner without the need of expensive components.

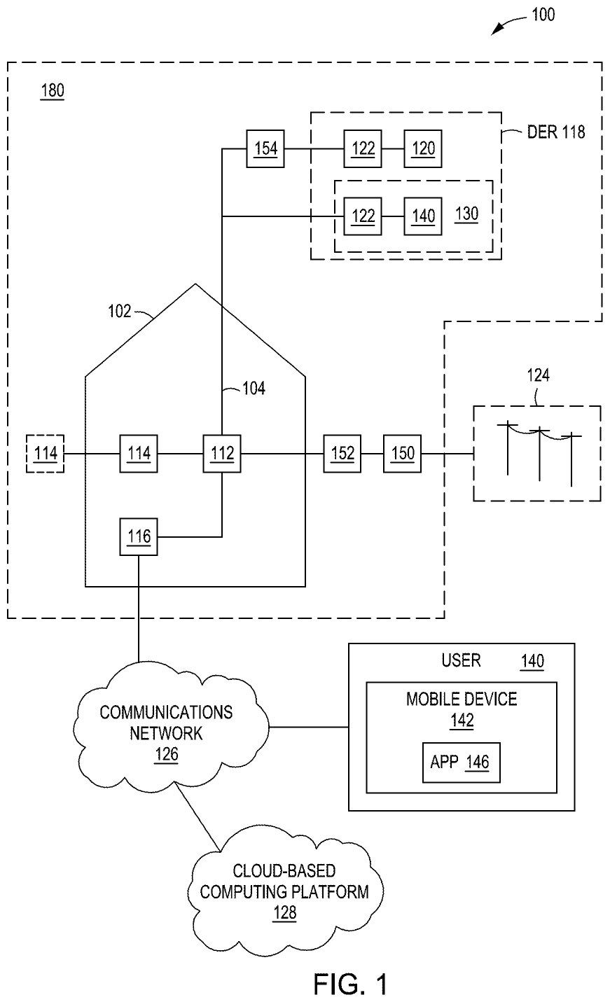

FIG. 1 is a block diagram of a system 100 (e.g., an energy management system or power conversion system) in accordance with one or more embodiments of the present disclosure. The diagram of FIG. 1 only portrays one variation of the myriad of possible system configurations. The present disclosure can function in a variety of environments and systems.

The system 100 comprises a structure 102 (e.g., a user's structure), such as a residential home or commercial building, having an associated DER 118 (distributed energy resource). The DER 118 is situated external to the structure 102. For example, the DER 118 may be located on the roof of the structure 102 or can be part of a solar farm. The structure 102 comprises one or more loads (e.g., appliances, electric hot water heaters, thermostats/detectors, boilers, water pumps, and the like), one or more energy storage devices (an energy storage system 114), which can be located within or outside the structure 102, and a DER controller 116, each coupled to a load center 112. Although the energy storage system 114, the DER controller 116, and the load center 112 are depicted as being located within the structure 102, one or more of these may be located external to the structure 102. In at least some embodiments, the energy storage system 114 can be, for example, one or more of the energy storage devices (e.g., IQ Battery 10©) commercially available from Enphase® Inc. of Petaluma, CA. Other energy storage devices from Enphase® Inc. or other manufacturers may also benefit from the inventive methods and apparatus disclosed herein.

The load center 112 is coupled to the DER 118 by an AC bus 104 and is further coupled, via a meter 152 and a MID 150 (e.g., microgrid interconnect device), to a grid 124 (e.g., a commercial/utility power grid). The structure 102, the energy storage system 114, DER controller 116, DER 118, load center 112, generation meter 154, meter 152, and MID 150 are part of a microgrid 180. It should be noted that one or more additional devices not shown in FIG. 1 may be part of the microgrid 180. For example, a power meter or similar device may be coupled to the load center 112.

The DER 118 comprises at least one renewable energy source (RES) coupled to power conditioners 122. For example, the DER 118 may comprise a plurality of RESs 120 coupled to a plurality of power conditioners 122 in a one-to-one correspondence (or two-to-one). In embodiments described herein, each RES of the plurality of RESs 120 is a photovoltaic module (PV module), although in other embodiments the plurality of RESs 120 may be any type of system for generating DC power from a renewable form of energy, such as wind, hydro, and the like. The DER 118 may further comprise one or more batteries (or other types of energy storage/delivery devices) coupled to the power conditioners 122 in a one-to-one correspondence, where each pair of power conditioner 122 and a battery 141 may be referred to as an AC battery 130.

The power conditioners 122 invert the generated DC power from the plurality of RESs 120 and/or the battery 141 to AC power that is grid-compliant and couple the generated AC power to the grid 124 via the load center 112. The generated AC power may be additionally or alternatively coupled via the load center 112 to the one or more loads and/or the energy storage system 114. In addition, the power conditioners 122 that are coupled to the batteries 141 convert AC power from the AC bus 104 to DC power for charging the batteries 141. A generation meter 154 is coupled at the output of the power conditioners 122 that are coupled to the plurality of RESs 120 in order to measure generated power.

In some alternative embodiments, the power conditioners 122 may be AC-AC converters that receive AC input and convert one type of AC power to another type of AC power. In other alternative embodiments, the power conditioners 122 may be DC-DC converters that convert one type of DC power to another type of DC power. In some of embodiments, the DC-DC converters may be coupled to a main DC-AC inverter for inverting the generated DC output to an AC output.

The power conditioners 122 may communicate with one another and with the DER controller 116 using power line communication (PLC), although additionally and/or alternatively other types of wired and/or wireless communication may be used. The DER controller 116 may provide operative control of the DER 118 and/or receive data or information from the DER 118. For example, the DER controller 116 may be a gateway that receives data (e.g., alarms, messages, operating data, performance data, and the like) from the power conditioners 122 and communicates the data and/or other information via the communications network 126 to a cloud-based computing platform 128, which can be configured to execute one or more application software, e.g., a grid connectivity control application, to a remote device or system such as a master controller (not shown), and the like. The DER controller 116 may also send control signals to the power conditioners 122, such as control signals generated by the DER controller 116 or received from a remote device or the cloud-based computing platform 128. The DER controller 116 may be communicably coupled to the communications network 126 via wired and/or wireless techniques. For example, the DER controller 116 may be wirelessly coupled to the communications network 126 via a commercially available router. In one or more embodiments, the DER controller 116 comprises an application-specific integrated circuit (ASIC) or microprocessor along with suitable software (e.g., a grid connectivity control application) for performing one or more of the functions described herein. For example, the DER controller 116 can include a memory (e.g., a non-transitory computer readable storage medium) having stored thereon instructions that when executed by a processor perform a method for grid connectivity control, as described in greater detail below.

The generation meter 154 (which may also be referred to as a production meter) may be any suitable energy meter that measures the energy generated by the DER 118 (e.g., by the power conditioners 122 coupled to the plurality of RESs 120). The generation meter 154 measures real power flow (kWh) and, in some embodiments, reactive power flow (kVAR). The generation meter 154 may communicate the measured values to the DER controller 116, for example using PLC, othertypes of wired communications, or wireless communication. Additionally, battery charge/discharge values are received through other networking protocols from the AC battery 130 itself.

The meter 152 may be any suitable energy meter that measures the energy consumed by the microgrid 180, such as a net-metering meter, a bi-directional meter that measures energy imported from the grid 124 and well as energy exported to the grid 124, a dual meter comprising two separate meters for measuring energy ingress and egress, and the like. In some embodiments, the meter 152 comprises the MID 150 or a portion thereof. The meter 152 measures one or more of real power flow (kWh), reactive power flow (kVAR), grid frequency, and grid voltage.

The MID 150, which may also be referred to as an island interconnect device (IID), connects/disconnects the microgrid 180 to/from the grid 124. The MID 150 comprises a disconnect component (e.g., a contactor or the like) for physically connecting/disconnecting the microgrid 180 to/from the grid 124. For example, the DER controller 116 receives information regarding the present state of the system from the power conditioners 122, and also receives the energy consumption values of the microgrid 180 from the meter 152 (for example via one or more of PLC, other types of wired communication, and wireless communication), and based on the received information (inputs), the DER controller 116 determines when to go on-grid or off-grid and instructs the MID 150 accordingly. In some alternative embodiments, the MID 150 comprises an ASIC or CPU, along with suitable software (e.g., an islanding module) for determining when to disconnect from/connect to the grid 124. For example, the MID 150 may monitor the grid 124 and detect a grid fluctuation, disturbance or outage and, as a result, disconnect the microgrid 180 from the grid 124. Once disconnected from the grid 124, the microgrid 180 can continue to generate power as an intentional island without imposing safety risks, for example on any line workers that may be working on the grid 124.

In some alternative embodiments, the MID 150 or a portion of the MID 150 is part of the DER controller 116. For example, the DER controller 116 may comprise a CPU and an islanding module for monitoring the grid 124, detecting grid failures and disturbances, determining when to disconnect from/connect to the grid 124, and driving a disconnect component accordingly, where the disconnect component may be part of the DER controller 116 or, alternatively, separate from the DER controller 116. In some embodiments, the MID 150 may communicate with the DER controller 116 (e.g., using wired techniques such as power line communications, or using wireless communication) for coordinating connection/disconnection to the grid 124.

A user 140 can use one or more computing devices, such as a mobile device 142 (e.g., a smart phone, tablet, or the like) communicably coupled by wireless means to the communications network 126. The mobile device 142 has a CPU, support circuits, and memory, and has one or more applications 146 (e.g., a grid connectivity control application) installed thereon for controlling the connectivity with the grid 124 as described herein. The one or more applications 146 may run on commercially available operating systems, such as IOS, ANDROID, and the like.

In order to control connectivity with the grid 124, the user 140 interacts with an icon displayed on the mobile device 142, for example a grid on-off toggle control or slide, which is referred to herein as a toggle button. The toggle button may be presented on one or more status screen pertaining to the microgrid 180, such as a live status screen (not shown), for various validations, checks and alerts. The first time the user 140 interacts with the toggle button, the user 140 is taken to a consent page, such as a grid connectivity consent page, under setting and will be allowed to interact with toggle button only after he/she gives consent.

Once consent is received, the scenarios below, listed in order of priority, will be handled differently. Based on the desired action as entered by the user 140, the corresponding instructions are communicated to the DER controller 116 via the communications network 126 using any suitable protocol, such as HTTP(S), MQTT(S), WebSockets, and the like. The DER controller 116, which may store the received instructions as needed, instructs the MID 150 to connect to or disconnect from the grid 124 as appropriate.

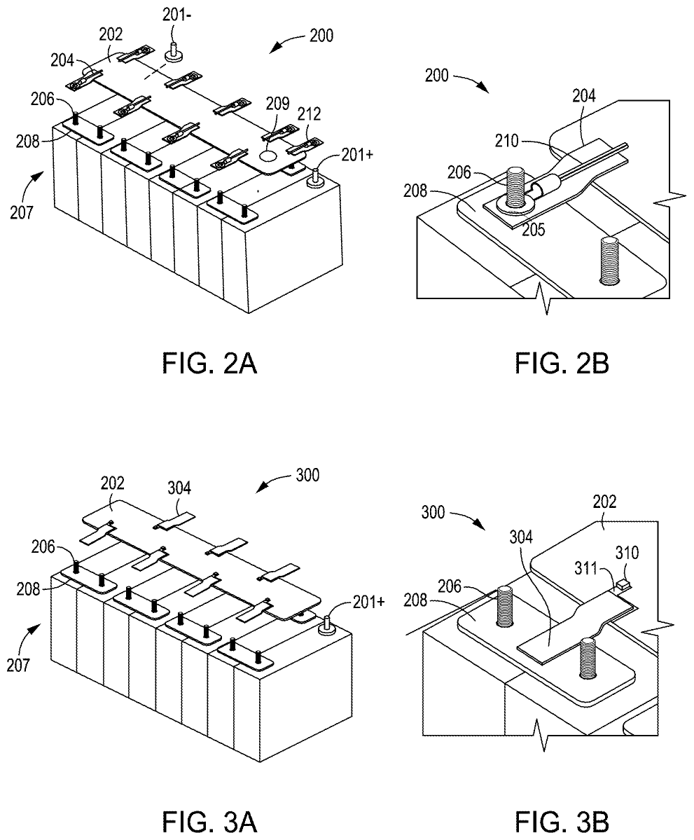

FIGS. 2A-2B are diagrams of a prismatic cell electrical configuration, in accordance with one or more embodiments of the present disclosure. For example, the prismatic cell electrical configuration (e.g., a battery pack 200) in FIGS. 2A and 2B is configured for use with the energy storage system 114 of FIG. 1. The battery pack 200 can comprise one or more battery cells. For example, the battery pack 200 can comprise 1, 2, 3, 4, 5, etc. battery cells. In at least some embodiments, the battery pack 200 can comprise eight battery cells 207. Each battery cell of the battery cells 207 comprises a cell stud terminal 206. Adjacent cell stud terminals can be electrically connected to each other via busbars 208 (seven busbars shown in FIGS. 2A and 2B). For example, in the illustrated embodiment, each battery cell of the battery cells 208 is connected in series via the bus bars 208, and on one side of the battery pack 200 four bus bars are used to connect eight adjacent cell stud terminals and on the other side of the battery pack 200 three bus bars are used to connect six adjacent cell stud terminals (e.g., two end terminals 201+ and 201− on the other side of the battery pack 200 are DC+/−main terminals, respectively).

The battery pack 200 comprises a PCBA 202 comprising one or more metal strips that are configured to connect/disconnect to/from the battery cells 207. For example, the PCBA 202 can comprise one or more metal strips that are configured to connect to a corresponding battery cell of the battery cells 207. For example, the PCBA 202 can comprise metal strips 204 that are configured to connect to a cell stud terminal 206 of the battery cells 207. For example, an amount of metal strips 204 can correspond with the number of busbars between the battery cells 207—the BMU 209 is configured to determine the voltage difference between the busbars, which would equal the battery cell voltage. In the illustrated embodiment, as there are eight battery cells there are eight corresponding metal strips. The metal strips 204 can be made from one or more metals. In at least some embodiments, the metal strips 204 can be made of at least one of aluminum, copper, or nickel.

The metal strips 204 can be attached to the PCBA 202 during a PCBA assembly process (e.g., an automated process). Each metal strip of the metal strips 204 can comprise a thermistor 210 (or other suitable electrical device, such as a thermocouple) that is bonded to each metal strip. In at least some embodiments, the thermistor 210 can be in the form of a ring lug 205 (or other suitable form) and can be attached to the PCBA 202 using one or more connectors (e.g., nuts, washers, etc.). During the battery pack 200 assembly, the metal strips 204 of the PCBA 202 can be dropped down over a cell stud terminal 206 and secured thereto with the one or more connectors (e.g., the nuts and washers).

A BMU 209 and components/modules associated therewith (e.g., one or more signal processing components) can be embedded in the PCBA 202 and configured to receive the temperature and voltage data/values via the thermistor 210. A BMU that can be used with the inventive concepts described herein is the BMU described in commonly-owned U.S. Provisional Patent Application Ser. No. 63/425,589, filed Nov. 15, 2022. The entire contents of which is incorporated herein by reference. In at least some embodiments, the one or more signal processing components can comprise sensing components/circuits that can operably communicate (via a wired or wireless configuration) with one or more components of the system 100 (e.g., the DER controller 116, the load center 112, etc.). For example, the one or more signal processing components can be configured to transmit/receive battery cell data to/from the DER controller 116, the load center 112, and/or the BMU 209 of the energy storage system 114. The battery cell data can comprise, for example, at least one of temperature or voltage data of the battery cells, battery connection data (e.g., whether the PCBA 202 is connected to the battery cells), battery status data (e.g., charge of battery), etc.

In at least some embodiments, the PCBA 202 can have a connector (e.g., a dedicated metal strip 212) that sends the temperature and voltage values (or the other previously described data) to a separate board comprising the BMU. For example, the PCBA 202 may only have voltage and temperature monitoring functions and the full BMU functions such as SOC/SOH and cell balancing circuit could be on a separate board. While PCBA 202 can also have all the BMU functions as described above.

FIGS. 3A-3B are diagrams of a prismatic cell electrical configuration, in accordance with one or more embodiments of the present disclosure. For example, unlike the metal strips 204, metal strips 304 can be spot welded or laser welded onto the busbars 208, which can also be an automated process. To collect temperature values, surface-mounted thermistors 310 can be placed on the same contact pad 311 as the metal strips 304. In the embodiments of FIGS. 3A-3B, the busbars 208 and the metal strips 304 can be highly thermally conductive so that a surface temperature of the contact pad 311 is similar to that of a temperature of the battery cells 207. In at least some embodiments, such as when the metal strips 304 are made from aluminum, copper and/or nickel, the thermal conductive values of the busbars 208 and the metal strips 304 can about 3×10\hat{ }7 S/m to about 6×10\hat{ }7 S/m.

The PCBAs described herein enable voltage and temperature data to be collected from the cells using a single low-cost part. Unlike conventional battery packs that use a wire harness for voltage/temperature sensing, the PCBAs described herein can be automated to eliminate manual assembly costs. Additionally, surface-mounted thermistors are, typically, cheaper than wire harness methods, and further reduce the manufacturing costs associated with battery pack assembly.

While the foregoing is directed to embodiments of the present disclosure, other and further embodiments of the disclosure may be devised without departing from the basic scope thereof, and the scope thereof is determined by the claims that follow.

What is claimed is:

1. A battery pack configured for use with an energy storage system, comprising:
a battery cell; and
a printed circuit board assembly comprising a metal strip configured to connect to the battery cell and provide at least one of temperature or voltage data of the battery cell to a battery management unit operably coupled to the printed circuit board assembly.

2. The battery pack of claim 1, wherein the metal strip comprises a thermistor.

3. The battery pack of claim 2, wherein the thermistor is bonded to the metal strip.

4. The battery pack of claim 1, wherein the metal strip is made from aluminum, copper, or nickel.

5. The battery pack of claim 1, wherein the battery cell comprises a cell stud terminal, and wherein the metal strip comprises a thermistor in a form of a ring lug that connects to the cell stud terminal.

6. The battery pack of claim 1, wherein a busbar couples to a cell stud terminal, and wherein the metal strip comprises a thermistor and is welded to the busbar.

7. An energy management system, comprising:
a distributed energy resource comprising a renewable energy source;
a load center connected to the renewable energy source; and
an energy storage system, comprising:
a battery pack comprising:
a battery cell; and
a printed circuit board assembly comprising a metal strip configured to connect to the battery cell and provide at least one of temperature or voltage data of the battery cell to a battery management unit operably coupled to the printed circuit board assembly.

8. The energy management system of claim 7, wherein the metal strip comprises a thermistor.

9. The energy management system of claim 8, wherein the thermistor is bonded to the metal strip.

10. The energy management system of claim 7, wherein the metal strip is made from aluminum, copper, or nickel.

11. The energy management system of claim 7, wherein the battery cell comprises a cell stud terminal, and wherein the metal strip comprises a thermistor in a form of a ring lug that connects to the cell stud terminal.

12. The energy management system of claim 7, wherein a busbar couples to a cell stud terminal, and wherein the metal strip comprises a thermistor and is welded to the busbar.
